(19) United States
(12) Patent Application Publication
(10) Pub. No.: US 2024/0370738 A1
(43) Pub. Date: Nov. 7, 2024

(54) DEVICE AND COMPUTER-IMPLEMENTED METHOD FOR SELECTING IMPLEMENTATIONS FOR OPERATORS FOR A NEURAL NETWORK, IN PARTICULAR FOR PROVIDING A COMPUTING DEVICE

(71) Applicant: Robert Bosch GmbH, Stuttgart (DE)

(72) Inventor: Dennis Sebastian Rieber, Albstadt (DE)

(21) Appl. No.: 18/651,247

(22) Filed: Apr. 30, 2024

(30) Foreign Application Priority Data
May 4, 2023 (DE) 10 2023 204 149.9

(51) Int. Cl. G06N 3/0985

(52) U.S. Cl. CPC G06N 3/0985

(57) ABSTRACT

A device and method for selecting implementations for operators for a neural network which includes a set of different operators of an operator type, for providing a computing device including the neural network. Subsets of the set of different operators are determined. For each subset, a set of implementations for the operators of the relevant subset is determined. For each implementation of the set, at least one metric is determined that characterizes an implementation of the neural network with the implementation on the computing device, in particular a latency, a throughput, or an energy consumption of the implementation of the neural network with the implementation on the computing device. For each set of implementations, one implementation is selected, wherein the implementations are selected that are Pareto-optimal with respect to the at least one metric and a size of an implementation of the neural network with the selected implementations.

### FIELD

The present invention relates to a device and a computer-implemented method for selecting implementations for operators for a neural network, in particular for providing a computing device.

### SUMMARY

According to an example embodiment of the present invention, a computer-implemented method for selecting implementations for operators for a neural network which comprises a set of different operators of an operator type, in particular for providing a computing device comprising the neural network, provides that subsets of the set of different operators are determined, wherein for each subset a set of implementations for the operators of the relevant subset is determined, wherein for each implementation at least one metric is determined from the set of implementations that characterizes an implementation of the neural network with the implementation on the computing device, in particular a latency, a throughput, and/or an energy consumption of the implementation of the neural network with the implementation on the computing device, and wherein for each set of implementations one implementation is selected, wherein the implementations are selected that are Pareto-optimal with respect to the at least one metric and a size of an implementation of the neural network with the selected implementations. The subsets represent a partitioning of the operators into groups that can be implemented with the same implementation. For example, the operators a, b, c, d are partitioned into subsets (a,b), (c), (d). The search spaces of the subsets are smaller and can be searched more efficiently for resource-efficient code. The metric and the size quantify the implementations. The implementations for the most resource-efficient code are selected from the Pareto front of the implementations found in the groups.

In one embodiment of the present invention, the implementation of the neural network is installed on the computing device. This provides an optimized neural network computing unit, i.e., the computing device, i.e., a computing unit that comprises hardware and software, the code of the implementation of the neural network installed on said unit. In one embodiment, the implementation of the neural network is provided for executing the artificial neural network. This provides the most resource-efficient code possible for executing a neural network.

Preferably, according to an example embodiment of the present invention, for each subset possible implementations of the operators in the subset are specified, wherein a search space for the implementation for the relevant subset comprises an intersection of the possible implementations. If there is more than one operator in a group, the intersection of the search spaces is determined. That is, in subsets (a,b), (c), (d) the search space of a and the search space of b are intersected in the subset (a,b).

Preferably, according to an example embodiment of the present invention, at least one subset of the set of different operators is determined, which comprises operators that can be implemented with the same implementation. This means that the operators are partitioned into groups that can be implemented with the same implementation.

According to an example embodiment of the present invention, it can be provided that a first subset of the set of different operators and a second subset of the set of different operators are determined, wherein the first subset and the second subset comprise common operators, wherein a first implementation is determined in a first search space for the implementation for the first subset and a second implementation is determined for the common operators in a second search space for the implementation for the second subset, wherein a first implementation of the neural network is determined in which the common operators of the first subset are implemented with the first implementation, wherein a second implementation of the neural network is determined in which the common operators of the first subset are implemented with the second implementation, wherein the at least one metric is determined for the implementations of the first implementation, wherein the at least one metric is determined for the implementations of the second implementation, and wherein either the first implementation or the second implementation is selected depending on a comparison of the metrics determined for the first implementation and the second implementation. This means that the first subset is re-evaluated depending on an implementation that is found for the second subset. This means that an implementation that has already been found is replaced by another implementation or is not so replaced, depending on the comparison of the metrics. For example, the first implementation is found in the first subset (a,b).

If a second implementation for (a,b) is found in a new search for the second subset (a,b,c), this second implementation in the first subset is compared with the first implementation for the subset (a,b).

According to an example embodiment of the present invention, preferably, the first implementation is replaced by the second implementation depending on the comparison if the at least one metric determined for the second implementation indicates a better implementation of the neural network than the at least one metric determined for the first implementation, in particular an implementation with lower latency, higher throughput, or lower energy consumption. As a result, a better second implementation replaces the first implementation.

According to an example embodiment of the present invention, preferably, at least two of the implementations for the subsets are searched for at least partly in parallel. This makes the search time-efficient.

According to an example embodiment of the present invention, preferably, an implementation of the neural network is determined in which the operators of a subset are implemented with the same implementation from the search space of the subset, wherein the at least one metric or the size is determined during an execution of the implementation on the computing device or in a simulation of the execution of the implementation on the computing device. This determines the relevant metric or size as accurately as possible.

According to an example embodiment of the present invention, preferably, an influence of an implementation of an operator on the size for the implementation of the neural network is determined which comprises this implementation of the operator, wherein the influence is stored, and wherein the size for an implementation of the neural network which comprises the same implementation for the same operator is determined depending on the stored influence. This allows measurement or simulation results to be reused.

According to an example embodiment of the present invention, a device for selecting implementations for operators for a neural network which comprises a set of different operators of an operator type, in particular for providing a computing device which comprises the neural network, comprises at least one processor and at least one memory, wherein the device is designed to execute instructions, upon execution of which by the at least one processor the method according to the present invention runs, wherein the at least one memory is designed to store the instructions.

A program for selecting implementations for operators for a neural network which comprises a set of different operators of an operator type, in particular for providing a computing device which comprises the neural network, provides that the program comprises instructions which can be executed by a computer, upon execution of which by the computer the method of the present invention runs.

Further advantageous embodiments of the present invention can be found in the following description and the figures.

### BRIEF DESCRIPTION OF THE DRAWINGS

FIG. 1 is a schematic representation of a device for selecting implementations for operators for a neural network, in particular for providing a computing device, according to an example embodiment of the present invention.

FIG. 2 shows a method for selecting the implementations, in particular for providing the computing device, according to an example embodiment of the present invention.

### DETAILED DESCRIPTION OF EXAMPLE EMBODIMENTS

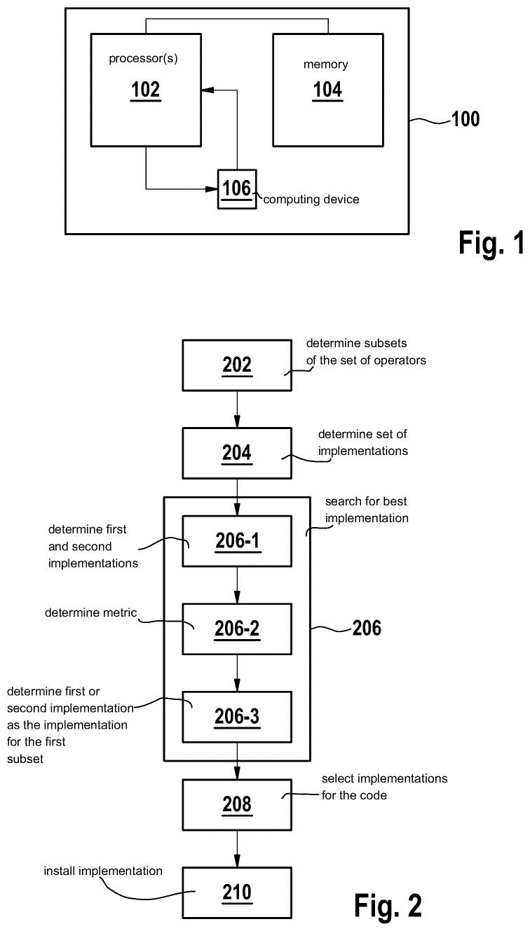

In FIG. 1, a device 100, for example a computer, is shown schematically. The device 100 comprises at least one processor 102 and at least one memory 104.

The device 100 is preferably designed to produce a computing device 106.

The computing device 106 comprises for example a deep neural network. The computing device 106 comprises for example at least one integrated circuit, in particular a microprocessor programmed with the deep neural network, a field programmable gate array (FPGA) programmed with the program, an application-specific integrated circuit (ASIC) programmed with the program.

The deep neural network comprises sequences of operators. An operator is for example implemented as a layer of the neural network. A neural network can comprise operators of different types, i.e., different operator types. Examples of types are a convolutional layer, e.g., Conv2D, a pooling layer, or a dense layer. The operators are used multiple times in the deep neural network and with different parameterization. The implementation of an operator is determined by its parameterization.

The at least one memory 104 is designed to store instructions of a method for selecting implementations for operators of the neural network. The at least one processor 102 is designed to execute the instructions.

A program for selecting implementations for operators of the neural network can be provided which comprises the instructions.

In the example, a neural network comprises a set of different operators of one operator type.

The method is described using the example of a set (a, b, c, d) of operators of the same operator type.

The method comprises a step 202.

In step 202, subsets of the set of operators are determined.

For example, the subsets ((a,b), (c), (d)) or ((a,b,d), (c)) are determined.

The number of subsets is determined by the Bell number

$${B}_{n + 1} = {\sum }_{k = 0}^{n} ( \begin{matrix}n \\ k\end{matrix} ) {B}_{k}$$

for n+1 elements of the set and Bk possible partitionings of the set.

For example, a first subset of the set of different operators and a second subset of the set of different operators are determined.

The first subset and the second subset may comprise different and/or common operators.

It can be provided that at least one subset of the set of different operators is determined which comprises operators that can be implemented with the same implementation. In the example, the first subset (a,b) and the second subset (a,b,d) comprise operators a and b which can be implemented with the same implementation.

For a set with n elements a₀a₁a₂ . . . aₙ the space of the partitions that differ from one another is limited by:

$${a}_{0} = 0 and {a}_{j + 1} \leq 1 + max ( {a}_{1} … {a}_{j} ) for 0 \leq j < n$$

For a set with four operators a, b, c, d, fifteen partitionings are possible:

0000, 0001, 0010, 0011, 0012, 0100, 0101, 0102, 0110, 0111, 0112, 0120, 0121, 0122, 0123

where 0, 1, 2, 3 describe the order of the operators in the subsets, e.g.,

$$( a , b , c , d ) = 0000$$

$$( ( a , b , d ) , ( c ) ) = 0010$$

$$( ( a , b ) , ( c ) , ( d ) ) = 0012$$

Subsequently, a step 204 is executed.

In step 204, for each subset a set of implementations for the operators of the relevant subset is determined.

In the example, a search space is determined using implementations for the operators of the relevant subset.

For example, for an operator n∈N^{T} from a set N^{T} of operators of the neural network of the operator type T the search space Sₙ^{T} is determined.

It can be provided that for each subset possible implementations of the operators in the subset are specified.

It can be provided that the search space comprises an intersection Sₗ^{T} of the possible implementations:

$${S}_{I}^{T} = {⋂}_{\{ n = 0 \}}^{{N}^{T}} {S}_{n}^{T}$$

In this search space, in a step 206, the best implementation with respect to the metric, for example with respect to latency, energy consumption, is searched for.

In step 206, at least one metric that characterizes an implementation of the neural network with the implementation on the computing device is determined. Examples of a metric are a latency, an energy consumption, or a throughput that occurs when executing the implementation in the neural network.

This means that the relevant metric of a particular implementation characterizes, for example, a latency, a throughput, or an energy consumption of the implementation of the neural network with the particular implementation on the computing device 106.

For example, a first implementation is determined in the search space of the first subset.

For example, a second implementation is determined in the search space of the second subset.

The first implementation and the second implementation are determined for different or for common operators.

In one embodiment, a first implementation of the neural network is determined in a step 206-1.

In the first implementation, the common operators of the first subset are implemented with the first implementation.

In one embodiment, a second implementation of the neural network is determined in step 206-1.

In the second implementation, the common operators of the first subset are implemented with the second implementation.

For example, an implementation of the neural network is determined in which the operators of a subset are implemented with the same implementation from the search space of the subset.

In one embodiment, in a step 206-2 the metric for the first implementation is determined.

In one embodiment, in step 206-2 the metric for the second implementation is determined.

For example, the metric is determined during an execution of the implementation on the computing device or in a simulation of the execution of the implementation on the computing device.

For example, the metric is determined during an execution of the implementation on the computing device or in a simulation of the execution of the implementation on the computing device.

It can be provided that an influence of an implementation of an operator on the metric for the implementation of the neural network is determined which comprises this implementation of the operator. For example, the influence is determined and stored.

It can be provided that the metric for an implementation of the neural network, which comprises the same implementation for the same operator, is determined depending on the stored influence.

In one embodiment, in a step 206-3, depending on a comparison of the metrics determined for the first implementation and the second implementation, either the first implementation or the second implementation is determined as the implementation for the first subset in the Pareto front.

For example, depending on the comparison, the first implementation is replaced by the second implementation as the implementation for the first subset if the metric determined for the second implementation indicates a better implementation of the neural network than the metric determined for the first implementation.

A parallel search for the implementations can be provided. This means for example that at least two of the implementations are searched for at least partly in parallel, particularly in terms of time.

A step 208 is then carried out.

In step 208, the implementations for the code are selected.

In the example, one implementation is selected per set of implementations.

The implementations are selected that are Pareto-optimal with respect to the metric and a size of the implementation of the neural network with the selected implementations.

The size is determined for different implementations of the neural network. The different implementations comprise different combinations of the implementations.

An implementation of the neural network with particular implementations on the computing device 106 is characterized by the size of the implementation.

The size characterizes, for example, a code size of the implementation of the neural network with the particular implementations on the computing device 106.

The code size is determined here via the number of subsets. Since all operators of a subset use the same implementation, the code size of a subset is determined by the implementation used. The sum of the code size over all subsets of a possible partitioning of the neural network into subsets thus determines the total size.

A Pareto front with the code size and at least one metric is formed over the partitionings examined. The Pareto front can be formed with one metric or also with a plurality of metrics, for example the latency and/or the energy consumption and/or the throughput. The metric used in each case is determined, for example, from the results of the previous step 206, in which the best implementation for the respective subsets was searched for.

The number of elements in the Pareto front is limited to a maximum number of possible subsets, the Bell number.

The implementations are selected depending on the metrics determined for each implementation and the size of the implementation of the neural network determined for different particular implementations.

For example, the implementations are selected for which the first size complies with a memory limit and for which the second size has the best performance, in particular in terms of latency, throughput, or energy consumption.

For example, the implementations are selected for which the first size indicates the smallest memory consumption and for which the second size indicates compliance with an upper or lower performance limit, in particular with regard to latency, throughput, or energy consumption.

For example, the implementations are selected for which the metric and size have the smallest distance from a theoretical optimum.

Subsequently, a step 210 is executed.

In step 210, in one embodiment, the implementation of the neural network is installed on the computing device 106.

In step 210, in one embodiment, the implementation of the neural network is provided for executing the artificial neural network.

1-11. (canceled)

12. A computer-implemented method for selecting implementations for operators for a neural network which includes a set of different operators of an operator type, for providing a computing device including the neural network, the method comprising the following steps:
determining subsets of the set of different operators;
for each subset of the subsets, determining a set of implementations for the operators of the subset;
for each implementation of the set of implementations, determining at least one metric that characterizes an implementation of the neural network with the implementation on the computing device, the at least one metric characterizing a latency, or a throughput, or an energy consumption of the implementation of the neural network with the implementation on the computing device; and
for each set of implementations, selecting one implementation;
wherein the implementations are selected that are Pareto-optimal with respect to the at least one metric and a size of an implementation of the neural network with the selected implementations.

13. The method according to claim 12, wherein the implementation of the neural network is installed on the computing device or the implementation of the neural network is provided for executing the artificial neural network.

14. The method according to claim 12, wherein, for each subset, possible implementations of the operators in the subset are specified, wherein a search space for each implementation for the subset includes an intersection of the possible implementations.

15. The method according to claim 12, wherein, at least one subset of the set of different operators is determined which includes operators that can be implemented with the same implementation.

16. The method according to claim 12, wherein a first subset of the set of different operators and a second subset of the set of different operators are determined, wherein the first subset and the second subset include common operators, wherein a first implementation is determined in a first search space for the implementation for the first subset and a second implementation is determined for the common operators in a second search space for the implementation for the second subset, wherein a first implementation of the neural network is determined in which the common operators of the first subset are implemented with the first implementation, wherein a second implementation of the neural network is determined in which the common operators of the first subset are implemented with the second implementation, wherein the at least one metric is determined for the implementations of the first implementation, wherein the at least one metric is determined for the implementations of the second implementation, and wherein either the first implementation or the second implementation is selected depending on a comparison of the at least one metric determined for the first implementation and the second implementation.

17. The method according to claim 16, wherein the first implementation is replaced by the second implementation depending on the comparison when the at least one metric determined for the second implementation indicates a better implementation of the neural network than the at least one metric determined for the first implementation, the better implementation being an implementation with lower latency, or higher throughput, or lower energy consumption.

18. The method according to claim 12, wherein at least two of the implementations for the subsets are searched for at least partly in parallel.

19. The method according to claim 12, wherein an implementation of the neural network is determined in which the operators of a subset are implemented with the same implementation from a search space of the subset, wherein the at least one metric or a size is determined during an execution of the implementation on the computing device or in a simulation of the execution of the implementation on the computing device.

20. The method according to claim 19, wherein an influence of an implementation of an operator on the size for the implementation of the neural network is determined which includes the implementation of the operator, wherein the influence is stored, and wherein the size for an implementation of the neural network which invlufrd the same implementation for the same operator is determined depending on the stored influence.

21. A device for selecting implementations for operators for a neural network which comprises a set of different operators of an operator type for providing a computing device which includes the neural network, the device comprising:
at least one processor; and
at least one memory;
wherein the device is configured to execute instructions, upon execution of which by the at least one processor, causing the processor to perform the following steps:
determining subsets of the set of different operators,
for each subset of the subsets, determining a set of implementations for the operators of the subset,
for each implementation of the set of implementations, determining at least one metric that characterizes an implementation of the neural network with the implementation on the computing device, the at least one metric characterizing a latency, or a throughput, or an energy consumption of the implementation of the neural network with the implementation on the computing device, and
for each set of implementations, selecting one implementation,
wherein the implementations are selected that are Pareto-optimal with respect to the at least one metric and a size of an implementation of the neural network with the selected implementations;
wherein the at least one memory stores the instructions.

22. A non-transitory computer-readable medium on which is stored a program including instructions for selecting implementations for operators for a neural network which includes a set of different operators of an operator type for providing a computing device which includes the neural network, the instructions, when executed by a computer, causing the computer to perform the following steps:
determining subsets of the set of different operators;
for each subset of the subsets, determining a set of implementations for the operators of the subset;
for each implementation of the set of implementations, determining at least one metric that characterizes an implementation of the neural network with the implementation on the computing device, the at least one metric characterizing a latency, or a throughput, or an energy consumption of the implementation of the neural network with the implementation on the computing device; and
for each set of implementations, selecting one implementation;
wherein the implementations are selected that are Pareto-optimal with respect to the at least one metric and a size of an implementation of the neural network with the selected implementations.
